(19) United States
(12) Patent Application Publication
(10) Pub. No.: US 2004/0145199 A1
(43) Pub. Date: Jul. 29, 2004

(54) Apparatus, system, and method for gripping and holding disk-shaped objects

(75) Inventors: Hans-Peter Haas, (US); Werner Heck, (US); Karlfried Oswald, (US)

Correspondence Address: KUNZLER & ASSOCIATES, 8 EAST BROADWAY, SALT LAKE CITY, UT, 84111, US

(73) Assignee: INTERNATIONAL BUSINESS MACHINES CORPORATION, Armonk, NY

(21) Appl. No.: 10/741,661

(22) Filed: Dec. 19, 2003

(30) Foreign Application Priority Data
Dec. 20, 2002 (DE) 02102862.6

(51) Int. Cl. B25J 15/06

(52) U.S. Cl. 294/64.3

(57) ABSTRACT

An apparatus for gripping a substantially flat object by means of vacuum forces, the apparatus comprising, a recessed portion, the outer shape of said recess portion adapted to receive the outer edge of the disk object, at least one air intake opening in the recessed portion, and a substantially V-shaped groove in the recessed portion arranged perpendicular to the flat plane of the disk object and differing from the edge of the disk object thereby forming a streaming channel when the disk object is in close proximity to the gripping apparatus such that when air is drawn into the one or more air intake openings, an attraction force is generated to draw the disk object into the gripping apparatus.

### CROSS-REFERENCES TO RELATED APPLICATIONS

This application is a national patent application and claims priority to German Patent Application Number 02102862.6 entitled “Device for Gripping and Holding Plate- or Disk-Shaped Objects” and filed on Dec. 20, 2002 for Hans-Peter Haas, et al., which is incorporated herein by reference.

### BACKGROUND OF THE INVENTION

The invention generally concerns apparatuses and devices for handling plate- or disk-shaped objects like Compact Disk (CD) or Digital Versatile Disk (DVD) media, disks or platters of a hard disk storage device, semiconductor wafers or the like. More particularly, the invention relates to a device for gripping and holding such objects from the edge by means of vacuum forces.

There exist different approaches for handling, i.e. gripping and holding, plate- or disk-shaped objects, like vacuum grippers, vacuum tweezers and vacuum pincettes. In a first very common approach or group of prior art approaches the object is gripped and held from a flat side face of the object using vacuum. Only exemplarily it is hereby referred to Japanese Patent Abstract JP 11087469 A2 disclosing a vacuum tweezer consisting of a pair of vacuum tweezers comprising a vacuum-chucked pad where a space part and an air vent hole are provided communicating with a vacuum source. When the backside of a semiconductor wafer is vacuum-chucked to the space part of the pad, the semiconductor wafer can be inspected while observing the entire surface although the front-side surface of the semiconductor wafer is prevented from having scratches and particles from adhering on the semiconductor wafer.

A similar vacuum tweezers is disclosed in Japanese Patent Abstract JP 59067618 A2. The object is attracted and held under vacuum by setting up a vacuum attracting section holding and an arm which support the attracting section and functions as a grip section. The vacuum tweezers has a circular space by a cover at a nose section of the arm. A cylindrical vacuum attracting section, and a lower section thereof is expanded in a funnel shape and which forms a vacuum attracting surface at its nose. A wafer is attracted and held to the attracting surface of the attracting section by operating an attracting valve. By this setup, the chipping and pollution of the wafer allegedly can be prevented and workability improved.

A second group of prior art approaches in the present field of handling devices grip and hold the object from its outer peripheral edge margin. An according device for use and handling a semiconductor wafer from a front face of the wafer is disclosed in U.S. Pat. No. 5,765,890. The device comprises fingers having tip portions adapted to engage the wafer for use in holding the wafer, and a frame mounting the fingers and locating the fingers for simultaneously engaging the wafer on the outer peripheral edge margin of the front face of the wafer while being free of engagement with a rear face of the wafer. Vacuum pressure passaging means terminates at the tip portions of the fingers for applying a vacuum pressure through the finger tip portions to the wafer to grip the wafer.

However, the pre-mentioned device does not enable gripping and holding of a plate- or disk-shaped object from the outer peripheral edge margin but moreover, as in the pre-mentioned approaches, from the backside of the wafer but in an edge margin of approximately 3 mm width on the wafer. Thus, the outer peripheral edge margin of the backside of the wafer cannot be accessed during wafer inspection. In addition, the device requires a frame mounting the fingers which has to be well-adjusted to the position of the wafer before the wafer can be gripped.

Another approach according to the second group of prior art approaches is disclosed in Japanese Patent Abstract JP 20260858 A2 which comprises a plurality of V-like grooves which support the edge part on the down side of a circumference of a wafer in vertical attitude. The device comprises one fixing claw which is fixed to a plate-like frame and comprises the mentioned V-like groove of almost the same radius as the wafer. The two movable claws are connected with a gripping actuator at upper two points of the wafer. The three claws of the device grip the wafer and move horizontally in the vertical attitude. Thus, the transportation of a wafer in vertical attitude is allowed even in vacuum. In view of the three claws, that device cannot be used in automated wafer handling processes because the wafer has to be well aligned before it can be gripped by that device.

As another example for the second group of approaches, it is referred to European Patent Application EP 776830 A1 entitled “Device for the removal and transfer of plate-shaped objects from a stuck using a suction device” which comprises means movable against a counter-force for generating a vacuum with a predetermined duration at a suction opening of the means. Transfer of plate-shaped objects such as ring disks or information carriers (compact disks), diskettes or floppy disks, is accomplished in an automated environment wherein the means has two U-shaped hollow elements in a concentric arrangement that are on the one hand slideable towards and into one another with there open ends and on the other hand are almost air-tightly sealed in their movement range in relation to one another to the extent that, when a vacuum is generated, a leak flow of predetermined size is achievable and hence also the vacuum duration that is predetermined for the removal and transfer of the object.

As a further example of the second group of approaches, it is referred to PCT application WO 33359 B1 disclosing a robotic arm for a holding and transferring semiconductor wafers. The robotic arm comprises effectors which include proximal and distal rest pads having pad and backstop portions that support and grip the wafer either by wafer peripheral edge contact or within an annular exclusion zone that extend inward from a peripheral edge of the wafer. An active contact point is movable by a vacuum actuated piston between a retracted wafer-loading position and an extended position that urges the wafer against the distal rest pads to grip the wafer at its edge or within the exclusion.

According to a third group of prior art approaches, Japanese Patent Abstract JP 08227931 A2 discloses a wafer side face grip and carrying-type semiconductor manufacturing apparatus which combines the two pre-discussed approaches i.e. gripping and holding the plate or disk like object via the edge and a face side. That gripping apparatus comprises a forefinger for holding the side face of a wafer and wafer contacting ends at the tops of both its sides or center end support. In particular, a tripod at the bottom of a wafer chuck and drive unit are provided to allow a vacuum exhaust hole and vacuum pump to be located at the bottom of the chuck.

According to a fourth group of prior art approaches, there are known vacuum grippers for handling thin, disk- or plate-shaped objects like semiconductor wafers which comprises an opening arranged on a plate-shaped carrier wherein a wafer is attracted to the plate-shaped carrier by means of Bernoulli forces generated by the airflow between the carrier and adjacent wafer.

The above prior art approaches are disadvantageous insofar as they do not allow a safe handling or haltering of the plate- or disk-like objects like CD-ROMs or DVDs only from the plate or disk edge whereby the front- and backside of the object remain completely accessible. On the other hand, most of the vacuum grippers, tweezers and pincettes require precise adjustment of the gripping arms in order to be arranged at the right position to grip the object. Therefore, these handling devices can be operated only poorly in an automated object handling environment.

### SUMMARY OF THE INVENTION

The present invention has been developed in response to the present state of the art, and in particular, in response to the problems and needs in the art that have not yet been fully solved by currently available methods and devices for gripping and handling plate- and disk-shaped objects. Accordingly, the present invention has been developed to provide a process, apparatus, and system for gripping and handling plate- and disk-shaped objects that overcome many or all of the above-discussed shortcomings in the art.

The objective of the present invention is to provide an apparatus or a device for handling plate- or disk-like objects avoiding the pre-discussed disadvantages of the prior art. This objective is attained by the features of the independent claims. Advantageous embodiments are subject matter of the subclaims.

The apparatus or device according to the invention, in the preferred embodiment, comprises two essentially symmetrically arranged gripping arms which are V-shaped at the inner side where an object to be gripped gets into contact with the gripping arms. The V-like grooves, in particular, differ from the edge shape of the object and thus a ring-like streaming channel is provided when the object gets into close contact with the gripping arms. The V-shape of the grooves, however, is preferable, but another embodiment with a different shape could be used provided a streaming channel is formed as the plate- or disk-like object comes into close proximity of the gripping device. The V-shape advantageously provides that the ring-like streaming channel will be established independently of small variations of the thickness of the object at its edge.

The gripping arms further comprise an intake air hole which is preferably arranged about in the symmetry axis of the gripping arms. Thus, when the object to be gripped is in close contact with the gripping arms, an airflow is initiated through the intake air hole. This airflow causes a kind of leakage air stream initiated from the outer parts of the arms two the intake air hole. In one embodiment, the cross section of the mentioned streaming channel is very small and in the order of <<1 mm², then the air streaming through the channel is Bernoulli-like and thus increases the attraction force between the outer edge of the object and the inner side of the gripping arms. In other words, the Bernoulli effect considerably enhances the attracting forces to be sufficient that the object is haltered by the gripping arms via the plate or disk edge.

For these reasons, both side faces of the plate- or disk-like object are substantially accessible even after the object is gripped and thus both sides can be processed in e.g. semiconductor processing steps from both sides without the requirement to release an existing connection and to re-grip the object after having rotated the object along one plate or disk edge. Thereupon, the two flat sides of the object may be accessible for the processing device only by rotating the object by means of the gripping apparatus or device itself.

In case of disk-like objects, another advantage vis-à-vis the prior art is that an object already being haltered by the gripping apparatus or device can even be rotated in the main plane of the object wherein the attraction forces between the edge of the object and the gripping arms remain essentially unchanged.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a perspective overview of a gripping device according to the invention with an already haltered circular-shaped object (e.g. CD-ROM);

FIG. 2A is another schematic block diagram illustrating the top view of the gripping device depicted in FIG. 1;

FIG. 2B is a schematic block diagram illustrating a side cut view of the gripping device depicted in FIG. 1, wherein the gripping device is cut along its symmetry axis;

FIG. 3 is a schematic block diagram illustrating an enlarged side view of the inner side of the gripping arm for illustration of the attraction forces along the edge of a disk-like object according to the invention; and

FIG. 4 is a schematic block diagram illustrating a top view on a further embodiment of the gripping device according to the invention for handling square-shaped objects.

### DETAILED DESCRIPTION OF THE INVENTION

Many of the functional units described in this specification have been labeled as modules, in order to more particularly emphasize their implementation independence. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as hardware modules, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

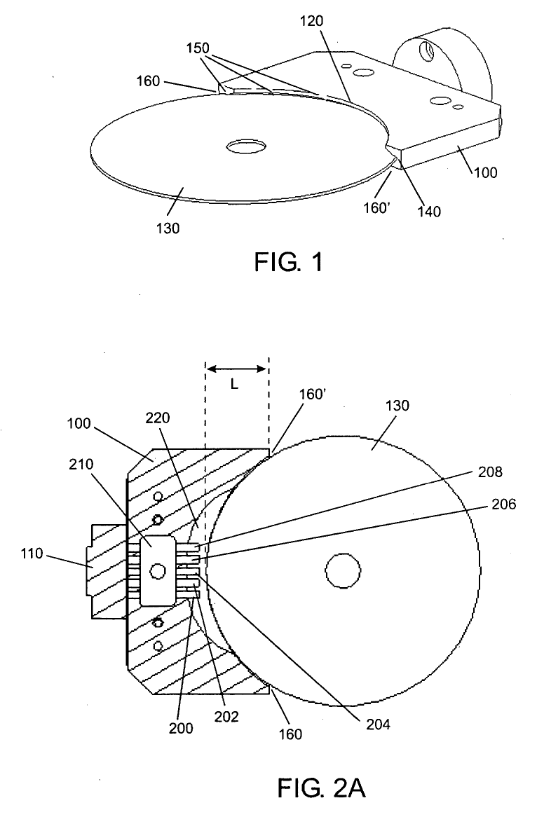

FIG. 1 depicts a perspective view of a vacuum gripper device in accordance with the invention. The gripper device mainly consists of a vacuum grip element 100 that is fixedly attached to a gasket element 110 by which the gripper device can be mounted to a corresponding (not shown) gasket of a vacuum pump. The vacuum grip element 100, in particular, comprises a recess portion 120 which shape in a top view on the shown device, is accustomed to the outer shape of the object to be handled by the gripping device.

In the present view, the gripping device is already haltering a CD-ROM 130 as an example for a disk-like object. Along said recess portion 120, there is provided a preferably V-shaped groove 140 wherein the cross-sectional shape is adapted to the shape of the outer edge of the CD-ROM 130 so that when being in close contact to the V-shaped groove 140 a narrow flow channel is provided between the outer edge of the CD-ROM 130 and the inner part of the V-shaped groove 140. However, instead of the shown V-shaped groove, other shapes can be used which provide not a constant but a radially extending groove width. Through that flow channel a vacuum airflow 150 is generated if the gasket 110 is connected with a (not shown) vacuum pump whereby the streaming air is passing into the flow channel at the V-shaped groove 140 by way of inlet openings 160, 160′. The streaming airflow 150 causes that the outer edge of the CD-ROM 130 being in close contact with the V-shaped groove 140 experiences an attracting force through the known Bernoulli effect due to the capillary streaming of the airflow through the flow channel.

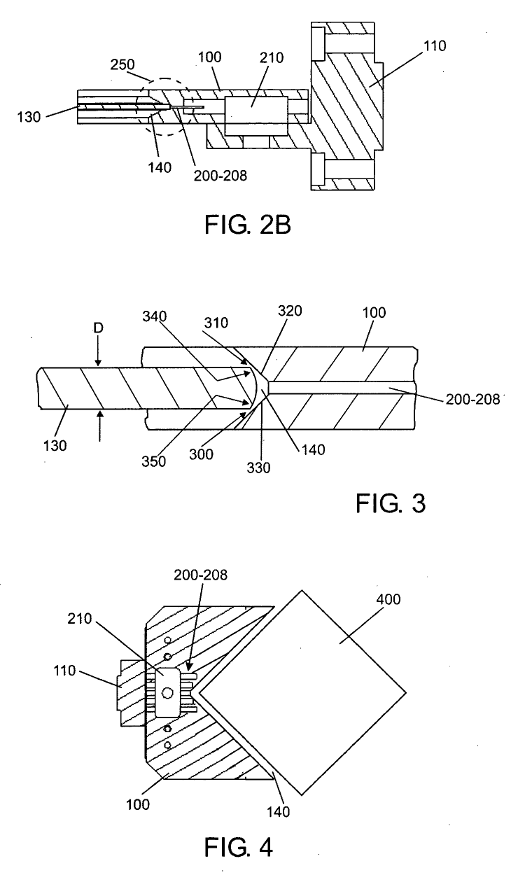

FIG. 2A depicts a top view of the gripping device shown in FIG. 1 wherein the vacuum grip element 100 and the gasket 110 are cut along the plane of the CD-ROM 130. It should be mentioned that FIG. 2A uses the same reference numerals as FIG. 1 for identical features. From the cut view in FIG. 2A it can be seen that, in the present embodiment, five vacuum intake holes 200-208 are provided for generating the necessary airflow in order to cause the pre-mentioned attraction forces between the outer edge of the CD-ROM 130 and the inner face of the V-shaped groove 140. However, the five intake holes 200-208 are only exemplary and have the advantage that the possible vacuum air flow is considerably enhanced by means of the extension of the cross-section within the plane of the object but the shape of the groove must not be changed locally for fitting with only one intake hole of a relatively large diameter. However the five intake air holes 200-208, principally, can be replaced by only one intake hole or even a different number of intake air holes.

From FIG. 2A it is evident, that the radius of the vacuum grip element 100 defined in the present drawing plane is shaped to substantially fit with the shape of the outer edge of the object in that plane in order to provide that the mentioned flow channel is well established when approaching the object to the vacuum grip element 100. It is further evident from FIG. 2A that the mentioned recess portion 120 of the vacuum grip element 100 defines a gripping arm length ‘L’ that is necessary for effectively avoiding that the CD-ROM 130 can wobble in the shown view direction perpendicular to the drawing plane of FIG. 2A by means of the enhanced side guide forces provided by the arm length.

Further, FIG. 2A shows another embodiment of the invention where the V-shaped groove 140 of the first embodiment is broadened 220 at the inner part of the vacuum grip element 100. This broadening can be achieved by providing a small rectangular, or similar shaped channel arranged at the inner part of the V-shaped groove that extends inside the vacuum grip element 100 beyond the inner tip area of the V-shaped groove. By means of that broadened flow channel 220, the vacuum space is enlarged so that the net attraction force on the outer edge of the CD-ROM 130 is increased and thus the entire attraction force onto the CD-ROM 130 is increased. It is emphasized that in the second embodiment shown in FIG. 2A, the attraction forces are not resulting from the pre-mentioned Bernoulli effect but by the increased vacuum force on the increased edge area of the CD-ROM 130 that is exposed to the vacuum generated within the enlarged channel 220.

FIG. 2B shows a sectional side view of the gripping device depicted in FIG. 1. In that sectional view especially the V-shaped groove 140 is illustrated more clearly than in the views of the other FIGURES. For a better understanding of the capillary channel provided by the interaction between the outer edge of the CD-ROM 130 and the inner side of said groove 140, FIG. 3 refers to the enlarged and more detailed sectional view in FIG. 2B marked by circle 250. In addition, FIG. 2B also depicts in more detail the arrangement of the vacuum intake air holes 200-208 and how they are connected to an air passage 210.

As mentioned above, FIG. 3 illustrates in more detail how the capillary channel 140 is generated when a CD-ROM 130 is in close contact with the V-shaped groove 140. Due to the sealing contact on both sides 300, 310 of the outer edge of CD-ROM 130 the capillary channel 140 is provided along the V-shaped groove depicted in FIG. 1. As can be seen from FIG. 3, the thickness ‘D’ of the CD-ROM 130 need not be defined precisely since the inclined areas 320, 330 of the V-shaped groove 140 will automatically fit with the shape of the outer edges 340, 350 of the CD-ROM 130 and thus compensate thickness variations.

However, it is understood hereby that the gripping device according to the invention can also be applied to objects not comprising a circular- or oval-shaped outer edge as the pre-described CD-ROMs or DVDs. FIG. 4 is another embodiment of the present invention which depicts a gripping device appropriate for handling a square-shaped thin plate 400 whereby the plate 400 is arranged with one of its tapering comers in close relationship to a V-shaped groove 140 of the vacuum grip element 100. In the drawing plane, the vacuum grip element 100 comprises a 90° angle-shaped form that fits with the mentioned outer shape of the plate 400. The only limitation for the potential outer shapes which can be handled by a gripping device according to the present invention is that the outer shape of the object should align with the shape of the groove 140 in order to allow the pre-described close relationship between the object and the groove 140. As in previously described embodiments, the vacuum grip element 100 is also fixedly connected to a gasket element 110. Other embodiments may have other means of providing an air flow through the air intake openings 200-208. The air stream along the V-shaped groove 140 is then fed into five vacuum intake holes 200-208 and an air passage 210.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for gripping a substantially flat object by means of vacuum forces, the apparatus comprising:
a recessed portion, the outer shape of said recess portion adapted to receive the outer edge of the disk object;
at least one air intake opening in the recessed portion; and
a substantially V-shaped groove in the recessed portion arranged perpendicular to the flat plane of the disk object and differing from the edge of the disk object to form a streaming channel when the disk object is in close proximity to the gripping apparatus wherein when air is drawn into the one or more air intake openings, an attraction force is generated to draw the disk object into the gripping apparatus.

2. The apparatus of claim 1, wherein the recessed portion further comprises a shape that closely conforms to the outer edge of the object.

3. The apparatus of claim 1, wherein the gripping apparatus is arranged so as to not interfere with access to the flat top or bottom portion of the object.

4. The apparatus of claim 1, wherein the portion of the gripping apparatus in close proximity to the disk object extends along the edges of the object sufficient to prevent unwanted movement of the disk object perpendicular to the flat plane of the disk object.

5. The apparatus of claim 1, wherein the one or more air intake openings of the recessed portion are arranged to be at the midpoint between the two ends of the recessed portion so that the formed streaming channel is approximately equal on both sides.

6. The apparatus of claim 1, wherein the area of the streaming channel formed when the disk object is in close proximity to the V-shaped channel is approximately 1 mm².

7. The apparatus of claim 1, wherein the air drawn through the streaming channel sufficient to provide a Bernoulli effect force on the object.

8. The apparatus of claim 1, further comprising a streaming space of relatively large cross section that allows a vacuum force to attract the disk object to the gripping apparatus.

9. The apparatus of claim 8, further comprising a streaming space that is V-shaped at the outer edges of the recessed portion, the streaming space broadening toward the inner part of the gripping apparatus and extending into the gripping element to allow a greater vacuum force.

10. A system for gripping a substantially flat object by means of vacuum forces, the system comprising:
a recessed portion, the outer shape of said recess portion adapted to receive the outer edge of the disk object, wherein the recessed portion further comprises a shape that closely conforms to the outer edge of the object and arranged so as to not interfere with access to the flat top or bottom portion of the object;
at least one air intake opening in the recessed portion, the air intake openings of the recessed portion are arranged to be at the midpoint between the two ends of the recessed portion so that the formed streaming channel is approximately equal on both sides; and
a substantially V-shaped groove in the recessed portion arranged perpendicular to the flat plane of the disk object and differing from the edge of the disk object thereby forming a streaming channel when the disk object is in close proximity to the gripping apparatus wherein when air is drawn into the one or more air intake openings, a Bernoulli attraction force is generated to draw the disk object into the gripping apparatus.

11. The system of claim 10, wherein the portion of the gripping apparatus in close proximity to the disk object extends along the edges of the object sufficient to prevent unwanted movement of the disk object perpendicular to the flat plane of the disk object.

12. The system of claim 10, wherein the area of the streaming channel formed when the disk object is in close proximity to the V-shaped channel is approximately 1 mm².

13. The system of claim 10, further comprising a streaming space of relatively large cross section that allows a vacuum force to attract the disk object to the gripping apparatus.

14. The system of claim 13, further comprising a streaming space that is V-shaped at the outer edges of the recessed portion, the streaming space broadening toward the inner part of the gripping apparatus and extending into the gripping element to allow a greater vacuum force.

15. A method for gripping a substantially flat object by means of vacuum forces, the method comprising:
drawing air in an intake opening located in a recessed portion of a gripping device, the gripping device having a recessed portion closely conforming with the outer edge of the object, the intake opening located near the center to of the recessed portion;
drawing air through a streaming channel to the air intake opening, the streaming channel formed when the outer edge of the object is in close proximity with a V-shaped groove in a gripping element; and
attracting the object to the V-shaped groove with a Bernoulli effect force created by the air drawn through the formed streaming channel.

16. The method of claim 15, wherein the area of the streaming channel formed when the disk object is in close proximity to the V-shaped channel is approximately 1 mm².

17. The method of claim 15, further comprising a streaming space of relatively large cross section that allows a vacuum force to attract the disk object to the gripping apparatus.

18. The method of claim 15, further comprising a streaming space that is V-shaped at the outer edges of the recessed portion, the streaming space broadening toward the inner part of the gripping apparatus and extending into the gripping element to allow a greater vacuum force.

19. An apparatus for gripping a substantially flat object by means of vacuum forces, the method comprising:
means for drawing air in an intake opening located in a recessed portion of a gripping device, the gripping device having a recessed portion closely conforming with the outer edge of the object, the intake opening located near the center to of the recessed portion;
means for drawing air through a streaming channel to the air intake opening, the streaming channel formed when the outer edge of the object is in close proximity with a V-shaped groove in a gripping element; and
means for attracting the object to the V-shaped groove with a Bernoulli effect force created by the air drawn through the formed streaming channel.

20. The apparatus of claim 19, wherein the area of the streaming channel formed when the disk object is in close proximity to the V-shaped channel is approximately 1 mm².

21. The apparatus of claim 19, further comprising a streaming space of relatively large cross section that allows a vacuum force to attract the disk object to the gripping apparatus.

22. The apparatus of claim 19, further comprising a streaming space, the streaming space comprising a V-shape at the outer edges of the recessed portion, the streaming space broadening toward the inner part of the gripping apparatus and extending into the gripping element to allow a greater vacuum force.
